(19) United States
(12) Patent Application Publication
(10) Pub. No.: US 2025/0062713 A1
(43) Pub. Date: Feb. 20, 2025

(54) System and Method for Retrofitting Buildings with Roof Mounted Solar Power Plant

(71) Applicant: Curtis Kossman, Pittsburgh, PA (US)

(72) Inventor: Curtis Kossman, Pittsburgh, PA (US)

(21) Appl. No.: 18/805,431

(22) Filed: Aug. 14, 2024

Related U.S. Application Data
(60) Provisional application No. 63/532,650, filed on Aug. 14, 2023.

(51) Int. Cl. H02S 20/23

(52) U.S. Cl. CPC H02S 20/23

(57) ABSTRACT

A roof mounted solar power plant system includes at least one solar panel array frame. Each solar panel array frame includes a plurality of solar panels electrically coupled forming a solar panel array, a plurality of frame beam members supporting the solar panels and extending perpendicular to a longitudinal axis of the solar panels; a plurality of rail members coupled supporting the frame beam members, with each rail member substantially vertically aligned with a metal roof joist and a plurality of gravity support pedestals engaging the roof wherein the vertical loading of the solar power plant is substantially transmitted through the support pedestals; and a plurality of uplift anchor assemblies coupled to the metal decking and to the frame beam members, wherein vertical uplift forces on the solar power plant are substantially resisted by the uplift anchor assemblies.

### RELATED APPLICATIONS

This application claims priority to U.S. provisional patent application Ser. No. 63/532,650 filed Aug. 14, 2024, titled “System and Method for Retrofitting Buildings with Roof Mounted Solar Power Plant” which is incorporated herein by reference.

### BACKGROUND OF THE INVENTION

### Field of the Invention

The present invention relates to a roof mounted solar power plants.

### Background Information

A roof mounted solar power plant, also called a rooftop solar power system, or rooftop PV system, is a photovoltaic (PV) system that has its electricity-generating solar panels mounted on the rooftop of a residential or commercial building or structure. The various components of such a system include photovoltaic modules, mounting systems, cables, solar inverters and other electrical accessories.

The urban environment provides a large amount of empty rooftop spaces and can inherently avoid the potential land use and environmental concerns. Rooftop mounted systems are small compared to utility-scale solar ground-mounted photovoltaic power stations with capacities in the megawatt range, hence being a form of distributed generation. Most rooftop PV stations are Grid-connected photovoltaic power systems. Rooftop PV systems on residential buildings typically feature a capacity of about 5-20 kilowatts (kW), while those mounted on commercial buildings often reach 100 kilowatts to 1 Megawatt (MW). Very large roofs can house industrial scale PV systems in the range of 1-10 Megawatts.

The most commonly utilized components of a rooftop solar array. Though designs may vary with roof type (e.g. metal vs shingle), roof angle, and shading concerns, most arrays consist of some variation of the following components solar panels, mounting clamps, racking/rails, rail mounts, flashing, wiring, and micro-inverters.

Solar panels produce carbon free electricity when irradiated with sunlight. Often made of silicon, solar panels are made of smaller solar cells which typically may number six cells per panel. Multiple solar panels strung together make up a solar array. Solar panels are generally protected by tempered glass and secured with a metal frame such as an aluminum frame. The front of a solar panel is very durable whereas the back of conventional panels are generally more vulnerable. Bifacial solar panels should be mentioned herein and these are double-sided panels that use both the top and bottom sides to capture and transform the solar energy. Bifacial solar panels have been around since they were first used in the Soviet space program in the 1970s but they have generally been considered too expensive to produce for utility-scale projects.

Mounting clamps generally consist of brackets and bolts that secure solar panels to one another on the roof and onto the racking or rails. Clamps often vary in design in order to account for various roof and rail configurations.

Racking or rails are made of metal and often lie in a parallel configuration on the roof for the panels to lie on. It is important that the rails are level enough for the panels to be evenly mounted.

Rail mounts attach the rails and the entire solar panel array to the surface of the roof. These rail mounts are often L brackets that are bolted through flashing and into the rafters of the roof. Rail mounts vary in design due to the wide range of roof configurations and materials.

Flashings generally comprises a durable metal plate that provides a water resistant seal between the mounts and roof surface. Often, caulk is used to seal the flashing to the roof and it resembles a metal roof shingle.

Wiring cables are used to connect between panels and to connect to the micro-inverter or string inverter. No wiring cables should touch the roof surface or hang from the array to avoid weathering and the deterioration of the wiring cables (sometimes referred to just as wiring or just as cables).

Micro inverters are mounted to the bottom of the panel and convert DC power from the panels into AC power that can be sent into the grid. Micro inverters allow for the optimization of each panel when shading occurs and can provide specific data from individual panels. Inverters also can be utilized optimized for the part or all of the panel arrays.

As noted above, large commercial roofs can house industrial scale solar power plants in the range of 1-10 Megawatts, however the implementation of these systems raises some particular problems.

First, large commercial roof solar power plants are typically assembled in situ (on the roof) in a piece by piece assembly process that slows assembly time.

Secondly, large commercial roof solar power plants must also accommodate updraft loading. This is typically accommodated by ballast on the rail mounts, and the ballast greatly increases the roof loading and limits the size of the power-plant that may be supported upon the roof top.

Third existing large commercial roof solar power plants limit maintenance and repair of the roof and can greatly increase the cost of simple roof repairs or maintenance.

Fourth there is a need to maximize roof usage for the power plant structure for efficient large commercial roof solar power plants.

There remains a need for improving the retrofitting buildings with roof mounted solar power plant, particularly for large commercial roofs.

### SUMMARY OF THE INVENTION

The present invention addresses the deficiencies of the prior art and provides an efficient system and method for retrofitting buildings with roof mounted solar power plant particularly for large commercial roofs.

One aspect of the present invention provides a roof mounted solar power plant system for a building having a roof with metal roof joists or beams, and intervening metal or wood decking. The system comprises at least one solar panel array frame. Each solar panel array frame includes a plurality of electrically coupled solar panels forming a solar panel array, each panel having a longitudinal axis, wherein the plurality of solar panels extend along substantially (+/−ten degrees) the same or substantially (+/−ten degrees) parallel longitudinal axes. Each solar panel array frame includes a plurality of frame beam members extending perpendicular to the longitudinal axis of the solar panels, the frame beam members coupled to and supporting the plurality of solar panels. Each solar panel array frame includes a plurality of rail members coupled to and supporting the frame beam members, with each rail member substantially vertically aligned with a metal roof joist and a plurality of gravity support pedestals engaging the roof wherein the vertical loading of the solar power plant is substantially transmitted through the support pedestals. Substantially vertically aligned defines that some and preferably all of the gravity support pedestals will overlap in plan view with the flanges and preferably the webbing of the roof joists or beams. Each solar panel array frame includes a plurality of uplift anchor assemblies coupled to the metal or wood decking and to the frame beam members, wherein vertical uplift forces on the solar power plant are substantially resisted by the uplift anchor assemblies. Substantially resisted here defines that the majority of the resisting force against uplifting of the solar panels is through the uplift anchor assemblies.

One aspect of the present invention provides a roof mounted solar power plant system for a building including a reflective substrate on the roof of the building, having a reflective index for sunlight of at least 0.5; and at least one solar panel array frame, wherein each solar panel array frame includes a plurality of bifacial solar panels electrically coupled forming a solar panel array, each panel having a longitudinal axis, wherein the plurality of solar panels extend along substantially the same or substantially parallel longitudinal axes.

One aspect of the present invention provides a method of installing a roof mounted solar power plant system for a building having a roof with metal roof joists and intervening metal decking comprising the steps of providing at least one solar panel array frame, wherein each solar panel array frame comprises a plurality of solar panels electrically coupled forming a solar panel array, each panel having a longitudinal axis, wherein the plurality of solar panels extend along substantially the same or substantially parallel longitudinal axes and a plurality of frame beam members extending perpendicular to the longitudinal axis of the solar panels, the frame beam members coupled to and supporting the plurality of solar panels, wherein the plurality of frame beam members include lift points; assembling the at least one solar panel array frame on the ground; and lifting the at least one solar panel array frame onto the roof of the building via the lift points.

The advantages of the present invention will be clarified in the following description taken together with the attached figures in which like reference numerals represent like elements throughout.

### BRIEF DESCRIPTION OF THE DRAWINGS

FIG. 1 is a side elevation view of a roof mounted solar power plant system for a building having a roof with metal roof joists and intervening metal decking according to one embodiment of the present invention.

FIG. 2 is a schematic plan view of two separate solar panel array frames of the roof mounted solar power plant system according to Figure

FIG. 3 is a side elevational view of a gravity support pedestal of the roof mounted solar power plant system according to FIG. 1.

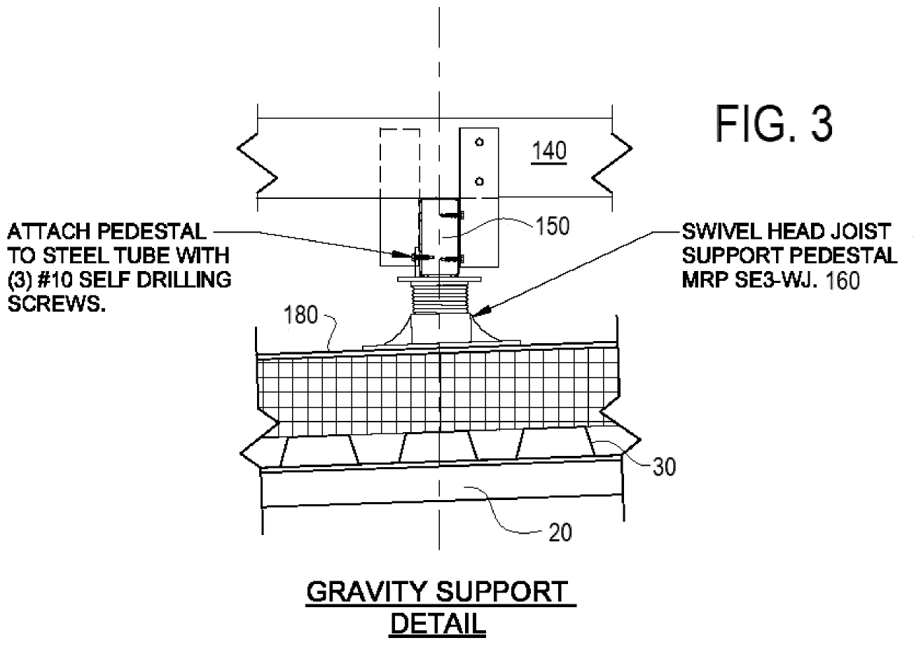

FIG. 4 includes a side elevation view and a plan view of an uplift anchor assembly of the roof mounted solar power plant system according to FIG. 1.

FIG. 5 is a side elevation view of the solar panel coupling of the roof mounted solar power plant system according to FIG. 1.

FIG. 6 is a side elevation view showing coupling of the frame beam members of solar panel array frames of the roof mounted solar power plant system according to FIG. 1.

FIG. 7 is a side perspective view of an alternate solar panel array frames of the roof mounted solar power plant system according to the present invention.

FIG. 8 is a side elevation view of the solar panel coupling in the solar panel array frame of FIG. 7.

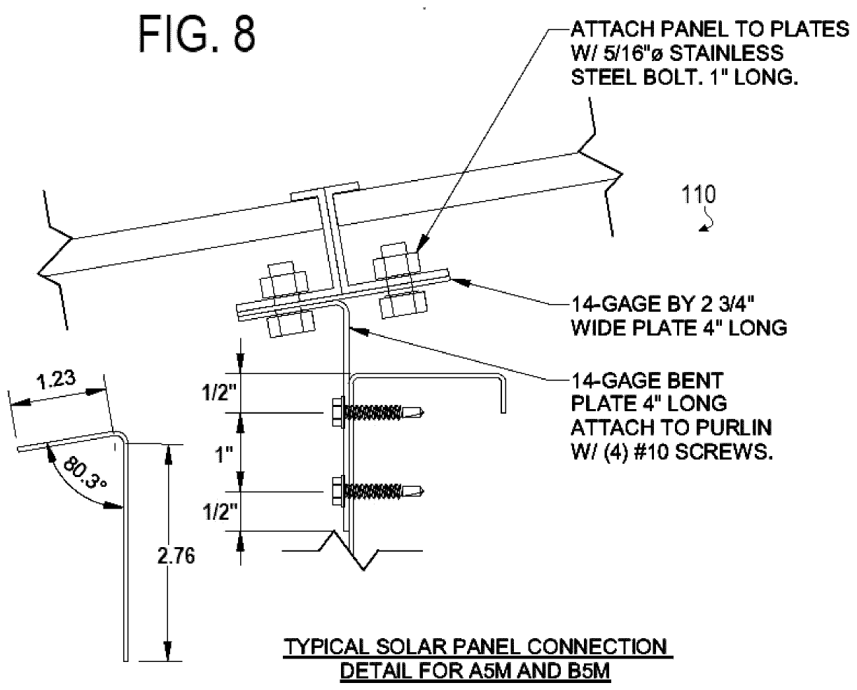

### DESCRIPTION OF THE PREFERRED EMBODIMENTS

The present invention addresses provides roof mounted solar power plant system 100 for a building 10 having a roof with metal roof joists 20 and intervening metal decking 30, particularly for large commercial roofs.

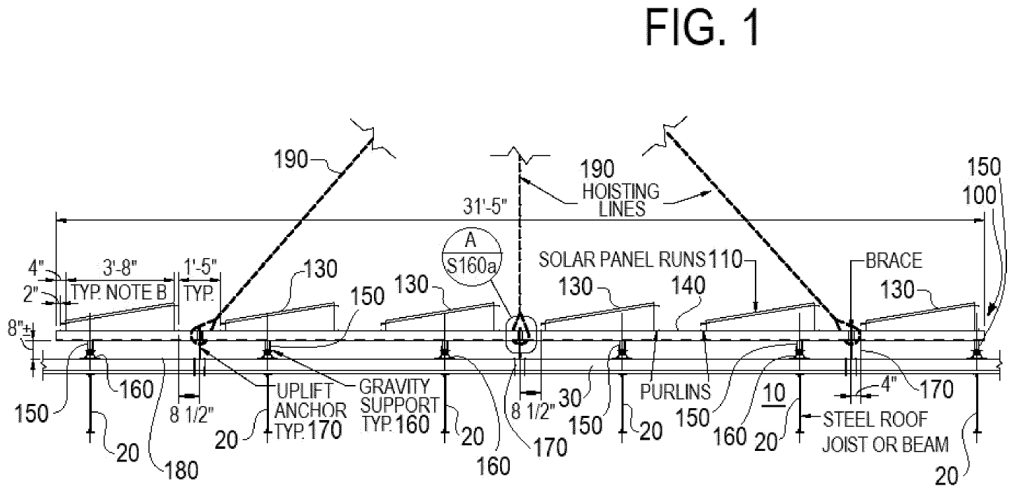

As detailed below FIG. 1 illustrates a roof mounted solar power plant system 100 for a building 10 having a roof with metal roof joists 20 and intervening metal decking 30 comprising at least one solar panel array frame 110, wherein each solar panel array frame 110 includes a plurality of solar panels 130 electrically coupled forming a solar panel array, each panel 130 having a longitudinal axis, wherein the plurality of solar panels 130 extend along substantially the same or substantially parallel longitudinal axes; a plurality of frame beam members 140 extending perpendicular to the longitudinal axis of the solar panels 130, the frame beam members 140 coupled to and supporting the plurality of solar panels 130; a plurality of rail members 150 coupled to and supporting the frame beam members 140, with each rail member 150 substantially vertically aligned with a metal roof joist 20 and a plurality of gravity support pedestals 160 engaging the roof, wherein the vertical loading of the solar power plant 100 is substantially transmitted through the support pedestals 160; and a plurality of uplift anchor assemblies 170 coupled to the metal decking 10 and to the frame beam members 140, wherein vertical uplift forces on the solar power plant 100 are substantially resisted by the uplift anchor assemblies 170.

### Solar Panel Array Frames 110

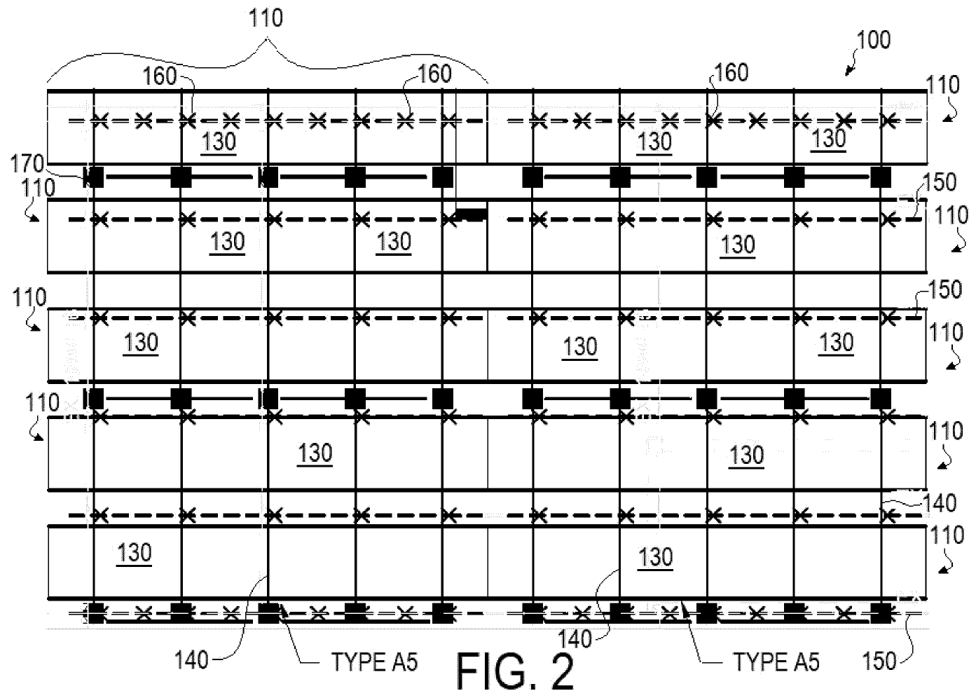

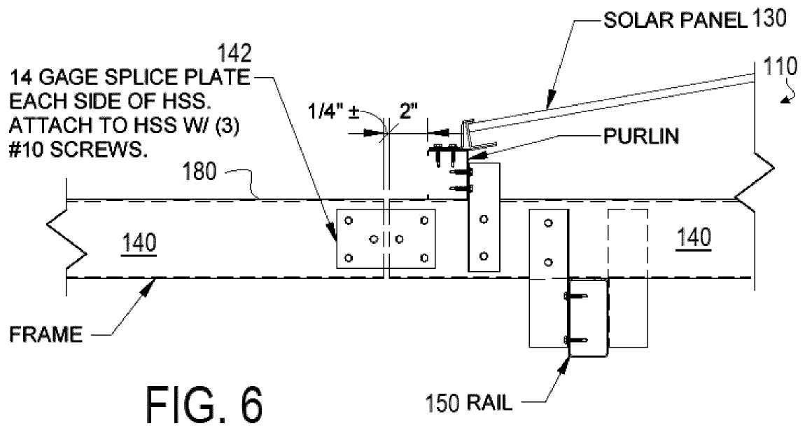

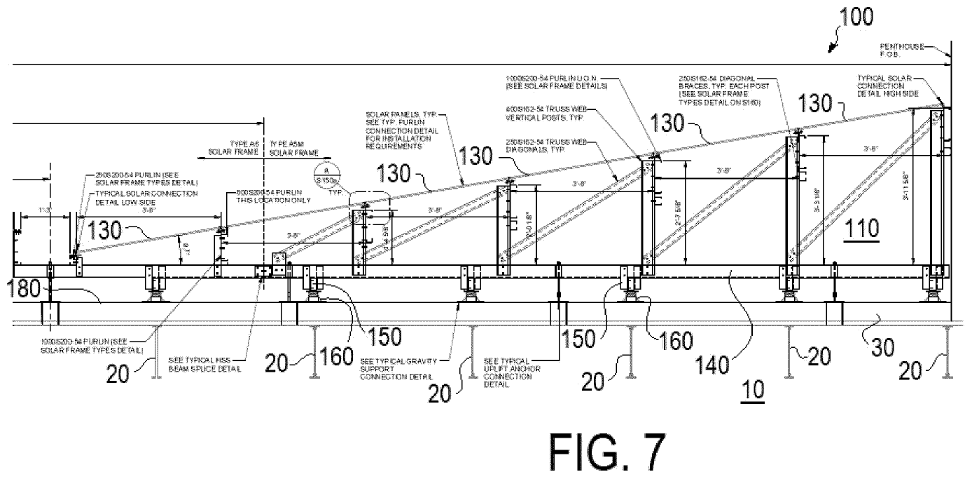

As shown in FIG. 2, and detailed herein, the present invention teaches modular solar panel array frames 110 than can take different sizes. In order to minimize complexity, a relative small number of unique orientations of the array frames 110 are necessary for the vast majority of implementations of the solar power plant 100. With less than ten frame 110 configurations (an exemplary two of which are shown in FIG. 2) the vast majority of industrial roofs can be adequately cover over 70% of the roof surface. FIG. 6 is a side elevation view showing coupling of the frame beam members 140 via splice plates 142 of adjacent solar panel array frames 110 of the roof mounted solar power plant system 100 according to FIG. 1. This easy coupling allows for the building of the modular system 100. FIG. 7 is a side perspective view of an alternate solar panel array frames 110 of the roof mounted solar power plant system 100 according to the present invention.

### Solar Panels 130

The electrical components of the solar panels 130 including the wiring/cables and inverters are conventional and not shown herein in detail.

The solar panels 130 of the present invention are bifacial solar panels 130 electrically coupled and forming the solar panel array. Bifacial solar panels 130 have solar cells on both sides. This enables the panels 130 to absorb light from the back as well as the front. Practically speaking, a bifacial solar panel 130 can absorb light that is reflected off the roof via reflective substrate 180. Bifacial solar modules or panels 130 have historically been described as being “effective in certain residential applications like pergolas and some ground mounted systems.” The general guidance (until the present system 100) has been “property owners considering a rooftop installation, bifacial panels don't make sense.” As discussed below and shown in the figures, here the panels 130 are elevated and angled away from a mounting surface, allowing light to reflect into the back of the panel 130. Manufacturers of suitable bifacial solar panels 130 include Hyundai Energy Solutions, LG Solar Panels and Jinko Solar.

As noted above each solar panel 130 has a longitudinal axis as the long axis of the rectangular panel. The plurality of solar panels extend along substantially the same or substantially parallel longitudinal axes. Substantially in this context means +/−ten degrees, although the panels 130 are preferably aligned to within three or even one degree.

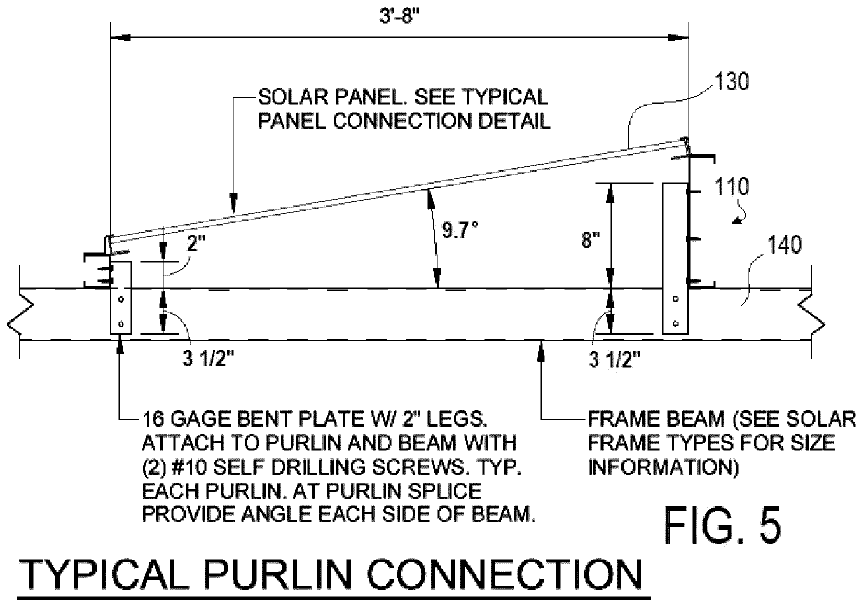

Conventional panel structures are often supported along their short sides whereby the supporting structure is spaced along the long axis. The present invention prefers to support each panel 130 with a coupling member along the long sides that is coupled to purlins which in turn is coupled to extending angle members from the frame members 140. This coupling is shown in FIG. 5. There are several advantages to this construction. The first is that each solar panel 130 is supported across the short side minimizing deflection (the moment of bending) of the panel 130 due to uploading forces as well as snow and rain. In other words, only minor beam deflection is expected to occur along the panel 130 due to both uploading wind forces and due to snow and rain events. Cyclical loading and flexing can, over time, can create micro-fractures within the panel and decrease the efficiencies of the panel, and the present construction minimizes this aspect. The present supporting structure minimizes such flexing by minimizing the spanned distance between supports. Another advantage is the ease of assembly and disassembly for initial construction and subsequent maintenance or repair if needed.

### Frame Beam Members 140

As suggested above each solar panel array frame 110 includes a plurality of frame beam members 140 extending perpendicular to the longitudinal axis of the solar panels 130, the frame beam members 140 are coupled to and supporting the plurality of solar panels 130 via the support flanges noted above. The frame beam members 140 form the backbone of the solar panel array frame 110 and the plurality of frame beam members 140 include lift points coupled to lifting cables 190 to be used to lift the solar panel array frames 110 into position for installation or removed for maintenance and repair. The maintenance and repair may be for the roof or the array.

It is the frame beam members 140 and associated lift points that allows for assembling the one solar panel array frames 110 at least partially on the ground greatly decreasing assembly time. Essentially, tools men and equipment need not be carted to the roof for installation. Much of the assembly can be accommodated on the ground. Following the assembly the lift points, located at uplift anchor assemblies 170 discussed below, can be used for lifting the partially assembled solar panel array frames 110 onto the roof of the building 10 via the lift points and cables 190.

The term partial assembly on the ground is used because the rail members 150 with the pedestals 160 will generally be prepositioned on the roof and substantially vertically aligned with a metal roof joists 20. The pedestals 160 are vertically adjustable so that variations within the roof level can be accommodated. Doing these steps on the roof with only the rail members 150 and associated pedestals 160 also improves the assembly process.

A portion of the anchor assembly 170 will be preinstalled as well and again this step performed without the remaining components will speed assembly.

After the solar panel array frames 110 are lifted into position the frame members 140 are connected to the rail members 150 via plates and the uplift anchor assemblies 170 are connected. Following these connections the vertical loading of the solar power plant 100 is substantially transmitted through the support pedestals 160 and the vertical uplift forces on the solar power plant 100 are substantially resisted by the uplift anchor assemblies 170 coupled to the deck 30.

### Rail Members 150

The system 100 includes a plurality of rail members 150 coupled to and supporting the frame beam members 140 extending perpendicular thereto. As shown in FIG. 1, each rail member 150 is substantially vertically aligned with a metal roof joist 20. Each rail member 150 includes a plurality of vertically adjustable gravity support pedestals 160 engaging the roof, specifically placed upon a reflective substrate 180 discussed below. When assembled the vertical loading of the solar power plant 100 is substantially transmitted through the support pedestals 160. The vertical adjustment accommodates minor roof variations. As discussed above the alignment of the rail members 150 preferably occurs before the partially assembled frame members and panels of the solar panel array frames 110 are lifted into position via a roof crane or the like.

The rail members 150 and the frame beam members 140 and the coupling elements associated therewith can be considered equivalent to the racking of the prior art solar panel structures.

### Uplift Anchor Assemblies 170

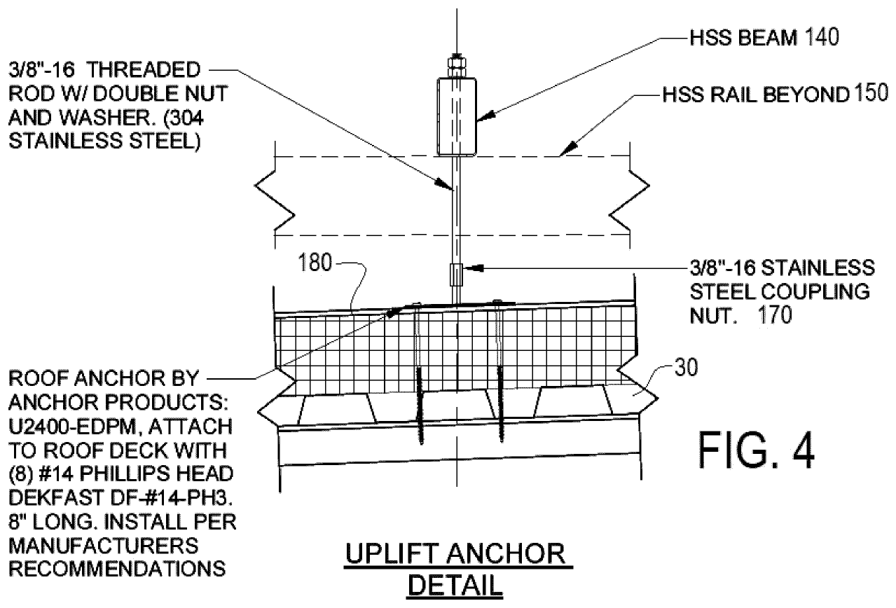

FIG. 4 includes a side elevation view and a plan view of an uplift anchor assembly 170 of the roof mounted solar power plant system 100 according to the invention. As noted above and shown in FIG. 1, a plurality of uplift anchor assemblies 170 are coupled to the metal decking and to the frame beam members 140, wherein vertical uplift forces on the solar power plant 170 are substantially resisted by the uplift anchor assemblies 170. The coupling of the anchors 170 to the metal decking 30 is generally between the joists/supports 20, and any distance from the joists 20 is adequate. The assembly 170 includes an anchor plate place upon the reflective substrate 180 (discussed below) and bolted to the decking 30 of the building 10 roof. The blots and anchor plate may be sealed with caulk or preferably with the same material forming the reflective substrate 180.

The anchor plate is coupled to the frame members generally at the lift point which may further include a reinforcing element and an eyelet.

### Reflective Substrate 180

As discussed above the present invention contemplates the inclusion of a reflective substrate 180 on the roof of the building 10 beneath each solar panel array frame 110 and having a reflective index for sunlight of at least 0.5, preferably at least 0.6, more preferably at least 0.7, and most preferably about 0.8. It should be noted that the color white exhibits a solar reflective index of about 80% or 0.80. The higher the better however above about 0.80 is not widely available. Elastomeric roof coatings applied by spraying rolling and general spreading may be effective. Examples include RUSTOLEUM Elastomeric roof coating, HENRY HE587046/HE587372 roof coating, JETCOAT COOL KING Reflective Acrylic Roof Coating, DICOR white EDPF Rubber Roof Coating, KST Coating White Roof Coating, RUBBERSEAL Liquid Rubber Waterproofing and Protective Coating, Liquid Rubber Waterproof Sealant, Liquid Rubber Foundation and Basement Sealant, and AMES BLUE MAX liquid rubber. Silicon based roof repair formulations have proven effective.

The reflective substrates (white having a reflective index of about 0.8) have shown in initial testing to increase the efficiencies of the bifacial solar power plant of FIG. 1 from 8-25%.

### Alternative Configuration

As noted above FIG. 7 is a side perspective view of an alternate solar panel array frame 110 of the roof mounted solar power plant system 100 according to the present invention. Here the solar panels 130 are aligned in a single inclined plane which maximizes surface area. As shown the frame itself includes posts and cross bracing members extending from the frame members 140 due to the extra height of the panels 130 on one end. The alternative is intended primarily to show the flexibility of the present invention.

### LEED Certification Advantage

LEED (Leadership in Energy and Environmental Design) is the world's most widely used green building rating system in the world. Available for virtually all building types, LEED certification provides a framework for healthy, highly efficient, and cost-saving green buildings, which offer environmental, social and governance benefits. LEED certification is a globally recognized symbol of sustainability achievement and leadership. Solar projects can provide a major contribution toward LEED certification. The primary LEED category pertaining to solar is the “Energy & Atmosphere” category, specifically EA Credit 2, the “On-Site Renewable Energy” credit. As of 2022 standards, this credit can provide up to 7 possible LEED points could represent over 17% of the points required for certification, depending on which level of certification developers are seeking. The number of LEED points awarded is determined by the percentage of the facility's energy costs that are offset by on-site renewable energy. Project performance is calculated by expressing the energy produced by renewable systems as a percentage of the building's annual energy cost. The present invention improves this certification by increasing the area of a roof covered by the system 100 increasing the energy output of the associated system 100, increasing the efficiency and output of the system 100 with bifacial panels 130 and reflective surface 180, increasing panel life, and decreasing the construction costs and time for greater project feasibility (i.e. decreased construction costs allows for a greater project investment).

The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. A roof mounted solar power plant system for a building having a roof with metal or wood roof joists or beams, and intervening metal or wood decking comprising at least one solar panel array frame, wherein each solar panel array frame comprises:
a plurality of solar panels electrically coupled forming a solar panel array, each panel having a longitudinal axis, wherein the plurality of solar panels extend along substantially the same or substantially parallel longitudinal axes;
a plurality of frame beam members extending perpendicular to the longitudinal axis of the solar panels, the frame beam members coupled to and supporting the plurality of solar panels;
a plurality of rail members coupled to and supporting the frame beam members, with each rail member substantially vertically aligned with a metal roof joist and a plurality of gravity support pedestals engaging the roof wherein the vertical loading of the solar power plant is substantially transmitted through the support pedestals; and
a plurality of uplift anchor assemblies coupled to the metal decking and to the frame beam members, wherein vertical uplift forces on the solar power plant are substantially resisted by the uplift anchor assemblies.

2. The roof mounted solar power plant system according to claim 1 wherein the solar panels of each solar panel array frame includes a plurality of bifacial solar panels electrically coupled and forming the solar panel array and further including a reflective substrate on the roof of the building beneath each solar panel array frame and having a reflective index for sunlight of at least 0.5.

3. The roof mounted solar power plant system according to claim 2 wherein the reflective substrate is a flexible silicone or other suitable membrane.

4. The roof mounted solar power plant system according to claim 2 wherein the plurality of frame beam members include lift points for selectively lifting the frame beam members and the plurality of solar panels of the solar panel array frame into and out of position for installation and for maintenance and repair.

5. The roof mounted solar power plant system according to claim 2 wherein the solar panels of each solar panel array frame are angled relative to a plane of the frame beam members.

6. The roof mounted solar power plant system according to claim 1 wherein the plurality of frame beam members include lift points for selectively lifting the frame beam members and the plurality of solar panels of the solar panel array frame into and out of position for installation and for maintenance and repair.

7. The roof mounted solar power plant system according to claim 1 wherein the solar panels of each solar panel array frame are angled relative to a plane of the frame beam members.

8. The roof mounted solar power plant system according to claim 1 wherein the support pedestals are vertically adjustable.

9. The roof mounted solar power plant system according to claim 1 wherein a plurality of the solar panel array frames are provided and cover at least 70% of the surface of the building roof or maximizing the available unobstructed roof area.

10. A roof mounted solar power plant system for a building comprising:
a reflective substrate on the roof of the building, having a reflective index for sunlight of at least 0.5; and
at least one solar panel array frame, wherein each solar panel array frame includes a plurality of bifacial solar panels electrically coupled forming a solar panel array, each panel having a longitudinal axis, wherein the plurality of solar panels extend along substantially the same or substantially parallel longitudinal axes.

11. The roof mounted solar power plant system according to claim 10 wherein each solar panel array frame further incudes a plurality of frame beam members extending perpendicular to the longitudinal axis of the solar panels supported on the roof above the reflective substrate, the frame beam members coupled to and supporting the plurality of solar panels.

12. The roof mounted solar power plant system according to claim 11 wherein each solar panel array frame further incudes a plurality of rail members coupled to and supporting the frame beam members, with each rail member substantially vertically aligned with a metal roof joist and a plurality of gravity support pedestals engaging the roof wherein the vertical loading of the solar power plant is substantially transmitted through the support pedestals.

13. The roof mounted solar power plant system according to claim 11 wherein each solar panel array frame further includes a plurality of uplift anchor assemblies coupled to the metal decking and to the frame beam members, wherein vertical uplift forces on the solar power plant are substantially resisted by the uplift anchor assemblies.

14. The roof mounted solar power plant system according to claim 13 wherein the support pedestals are vertically adjustable.

15. The roof mounted solar power plant system according to claim 13 wherein the plurality of frame beam members include lift points for selectively lifting the frame beam members and the plurality of solar panels of the solar panel array frame into and out of position for installation and for maintenance and repair.

16. The roof mounted solar power plant system according to claim 13 wherein the solar panels of each solar panel array frame are angled relative to a plane of the frame beam members.

17. A method of installing a roof mounted solar power plant system for a building having a roof with metal or wood roof joists and intervening metal or wood decking comprising the steps of:
providing at least one solar panel array frame, wherein each solar panel array frame comprises a plurality of solar panels electrically coupled forming a solar panel array, each panel having a longitudinal axis, wherein the plurality of solar panels extend along substantially the same or substantially parallel longitudinal axes and a plurality of frame beam members extending perpendicular to the longitudinal axis of the solar panels, the frame beam members coupled to and supporting the plurality of solar panels, wherein the plurality of frame beam members include lift points;
assembling the at least one solar panel array frame on the ground; and
lifting at least one solar panel array frame onto the roof of the building via the lift points.

18. The method of installing a roof mounted solar power plant system according to claim 17 further including the steps of vertically aligning a plurality of rail members having a plurality of gravity support pedestals with metal roof joists and coupling the rail members to the frame beam members, wherein the vertical loading of the solar power plant is substantially transmitted through the support pedestals.

19. The method of installing a roof mounted solar power plant system according to claim 18 further including the steps of coupling a plurality of uplift anchor assemblies to the metal decking and to the frame beam members, wherein vertical uplift forces on the solar power plant are substantially resisted by the uplift anchor assemblies.

20. The method of installing a roof mounted solar power plant system according to claim 18 further including the step installing a reflective substrate on the roof of the building beneath the at least one solar panel array frame, the reflective substrate having a reflective index for sunlight of at least 0.5.
